(19) United States
(12) Patent Application Publication
(10) Pub. No.: US 2016/0210253 A1
(43) Pub. Date: Jul. 21, 2016

(54) Serial bus system with switching modules

(71) Applicant: Bachmann GmbH, Feldkirch (AT)

(72) Inventors: Dominik MATT, Frastanz (AT); Michael SCHMID, Lochau (AT); Mathias JOCHUM, Hoerbranz (AT)

(21) Appl. No.: 15/000,265

(22) Filed: Jan. 19, 2016

(30) Foreign Application Priority Data
Jan. 19, 2015 (AT) GM8/2015

(51) Int. Cl. G06F 13/368; G06F 13/42; G06F 13/40

(52) U.S. Cl. CPC G06F 13/368; G06F 13/4022; G06F 13/4068; G06F 13/4282

(57) ABSTRACT

A serial bus system with a plurality of bus modules (2′-4′) connected thereto, wherein the data traffic can be administered on the serial bus (1) by means of at least one CPU bus master (13), wherein the bus modules (2′-4′) connected in the serial bus (1) are each distributed in a switching module (7-10) connected directly to the serial bus (1) and one or more simple modules (2-4) which are connected only to the switching module (7-10).

The invention relates to a serial bus system with bus modules according to the preamble of claim 1.

A serial bus system with bus modules integrated directly into the bus is described, for example, in DE 101 48 470 A1.

In serial data transmission, a plurality of bus subscribers communicate via a common transmission medium. So that each receives a chance to send and receive its data, agreements are necessary which regulate access to the transmission medium. In serial data transmission, a wide range of bus access methods are used in the field of the sensor/actuator level, such as master/slave, CSMA/CD, token passing, etc.

The wide range of bus access methods substantially use the message-oriented or the I/O-oriented transmission method. In the message-oriented transmission method, there are a plurality of different transmission protocols and interface implementations.

Even the simplest sensors and actuators communicate with the higher-level control by means of this transmission method. Here, the bus subscribers are connected with one another via a common transmission medium, such as a two-wire line. Wiring effort is thereby reduced considerably, and system expansions are easily possible. New system parts are then integrated into the existing wiring by disconnecting the existing bus line and connecting the new system part between the two disconnection points. No new additional wiring must be laid, as the signals of the new system part are transmitted via the existing transmission medium.

In DE 101 48 470 A1, it is understood that in an automation system, components with a modular assembly carrier, in which a plurality of assemblies is arranged, are to produce a connection to the neighboring assembly carriers.

DE 101 48 470 A1 therefore provides that a plurality of bus segments are present, wherein each bus segment has a star-shaped bus switching element. However, there is no indication of how the star-shaped bus switching element is formed.

Said document is therefore not able to provide an intelligent and mechanically stable connection to modules directly integrated in a bus (also referred to hereinafter as “bus module”) in which a ring connection is translated into a point-to-point connection.

The term “bus module” is understood to mean a module according to the prior art which has a complex electronic circuit for direct connection to the serial bus in connection with the characteristics of a “simple” I/O or switch module. However, the implementation of a complex electronic circuit in the bus module for direct connection to the serial bus is disadvantageous in several respects.

The object of the invention is therefore to develop a serial bus system with bus modules of the aforementioned type such that a faster data throughput is provided through the serial bus independent of the number of bus modules connected thereto, and such that in case of failure of the individual bus modules present in the bus, no disruption of the remaining bus subscribers occurs. Further, the maximum possible data transmission rate should always be available, regardless of the number of bus modules.

To achieve this object, the invention is characterized by the technical teaching of claim 1.

In order to better distinguish the modules according to the prior art from the modules according to the invention, the modules directly integrated in the bus structure according to the prior art are designated hereinafter as “bus modules,” while the modules according to the invention are divided into two parts and respectively divided into a switching module integrated directly into the bus structure and a “simple” standard module connected thereto. The “simple” standard module is thus only connected indirectly to the bus structure via the switching module.

A feature of the invention is thus that in a serial bus which is managed by a CPU bus master, individual complex modules (bus modules) themselves are no longer integrated in the bus, but rather so-called switching modules, which map the standard modules connected thereto to the bus only in a logical sense.

This results in the advantage over DE 101 48 470 A1 that only logical mappings of the standard module connected to the bus are present in the switching module and no direct connection of the known bus module with the serial bus itself takes place. In the mentioned publication DE 101 48 470 A1, however, a connection of the individual star-shaped connected bus modules was necessary, which is accompanied by the disadvantage of a high circuit complexity and considerable disturbances in case of failure of some modules.

The invention therefore provides that an intelligent, mechanically stable connection of switching modules to the bus structure is provided. After the modules are arranged only as module mappings in the serial bus structure of the serial bus in the form of the switching module arranged there, a ring connection is present only between the switching modules. A ring connection between individual complex bus modules which are directly integrated in the ring structure can therefore be dispensed with.

Only the switching modules then continues to take part in the data traffic in the serial bus, and no longer the standard modules, which are now constructed in a simplified manner.

This is associated with the advantage that now any desired number of standard modules can be connected into the bus structure without affecting the data traffic to the serial bus, as only the switching modules are connected in the serial bus, and the switching modules are connected in turn with the simple standard modules.

In this way, a faster data throughput is achieved in the bus structure, and the entire data traffic is not disrupted in the case of failure of a switching module, as the switching module then causes a through-connection and the other switching modules remain in the serial bus and are able to function there.

Even if simple modules fail, which were previously contained in the ring structure in the prior art, this does not lead according to the invention to a disruption of the serial bus system, as the switching modules then determine a failure of the module connected there based on their own intelligence and remove this module from the data traffic.

The invention is explained hereinafter in bullet form on the basis of the specified additional features:
Intelligent, mechanically stable connection of modules
   Translate the ring connection (between switching modules) to a point-to point connection (to modules)
   Enable a connection of modules flexible on the basis of data
   Bring the intelligence “close” to the (intrinsically dumb) I/O module
Translate the ring connection to a point-to-point connection
   Security from disruption—one defective module does not cause the failure of all
   (Short ring) via switching modules
   Point-to-point connection is “closed”
      No reflection, clean layout
   More data throughput possible for each module
      Can be used in conjunction with local intelligence
   CPU is not burdened by data transfer directly to the modules
      Creates own FPGA/System on Chip
Enable a connection of modules flexible on the basis of data
   Connect standard electronics without additional logic
      “I/O expander”—SPI input translated to digital signals
   “Speed grades” (frequency of the SPI bus)—there are both slow and fast connections in point-to-point connections
      Begin slow, with “better” modules, then faster
   No fixed protocol
      Configurable data transfer, data may depend on the module
      Data controller accepts “commands”
   For busbars kept at an abstract level—any electrical component can be connected
      They are all “just” data
   Interchangeable Fieldbus protocols to the switching module
Enable a connection of modules flexible on the basis of data
   Separate identification in module
      Read the “ID” independent from the rest
   Switching module has no “module types”
      Configuration rule comes from the module (not from the CPU)
      Each module brings its “language” and “dictionary” (commands and link to data)
   Standard components can be connected
      Connected elements need not function according to a special standard
      Only additional “ID register” with the “command description”
Intelligence is brought “close” to the I/O module
   Different I/O of different modules applied with intelligence
      Module itself can remain dumb
   Quick response of the individual modules, which are connected to a switching module (below bus cycle)
   Module-module communication
      (Preferably via the line module-switching module+switching module-module)
   Autonomous actuation of all modules of a switching module (“emergency operation”)
   Decentralized logic
      User application on the switching module (e.g. 61131)
Other characteristics
   (for example, USB) connector for diagnostics on the switching module
   Cooling
      “Intelligence” of the switching module is closer to the assembly carrier

The inventive subject of the present invention arises not only from the subject of the individual claims but also from the combination of the individual claims with one another.

All information and features disclosed in the documents, including the abstract, in particular the spatial embodiment shown in the drawings, are claimed as essential to the invention insofar as they are novel with respect to the prior art, either individually or in combination.

The invention is hereinafter described in greater detail with reference to drawings showing only one possible embodiment. From the drawings and their description follow further features and advantages essential to the invention.

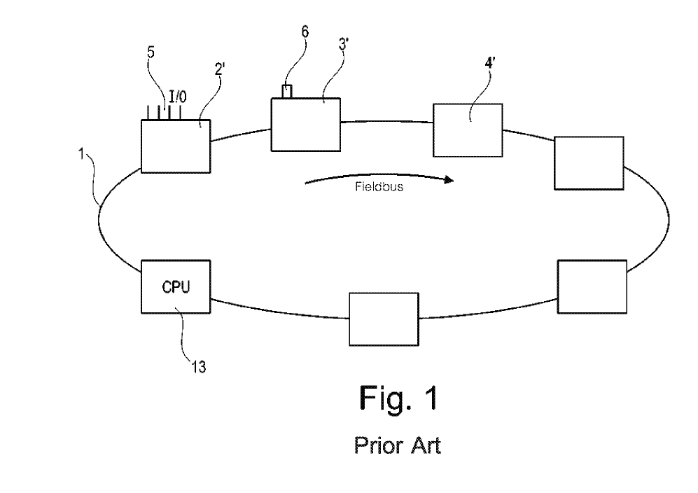

FIG. 1: shows a schematic block diagram of a serial bus according to the prior art

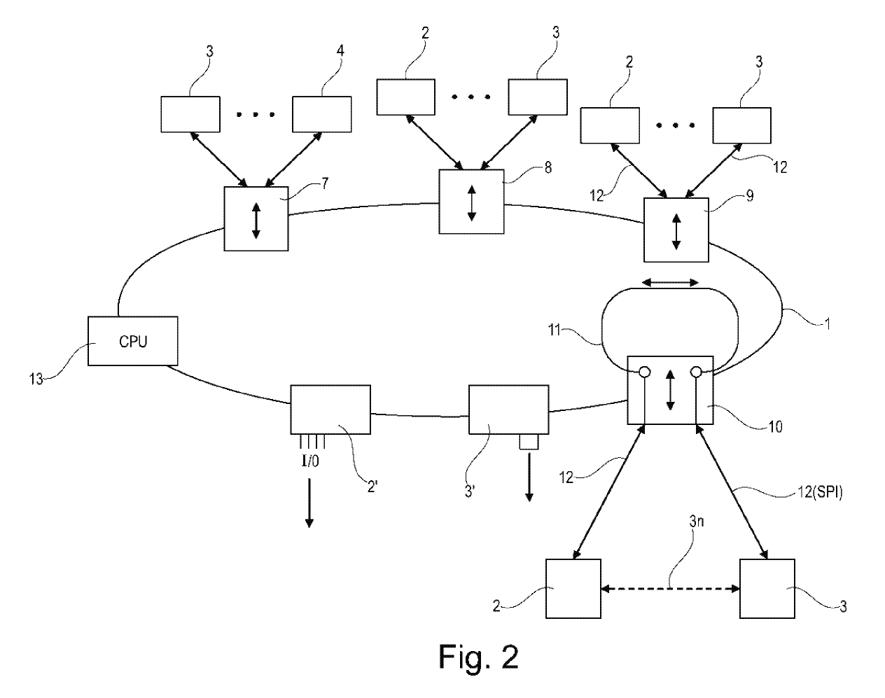

FIG. 2: shows a first exemplary embodiment of the invention in a schematic representation

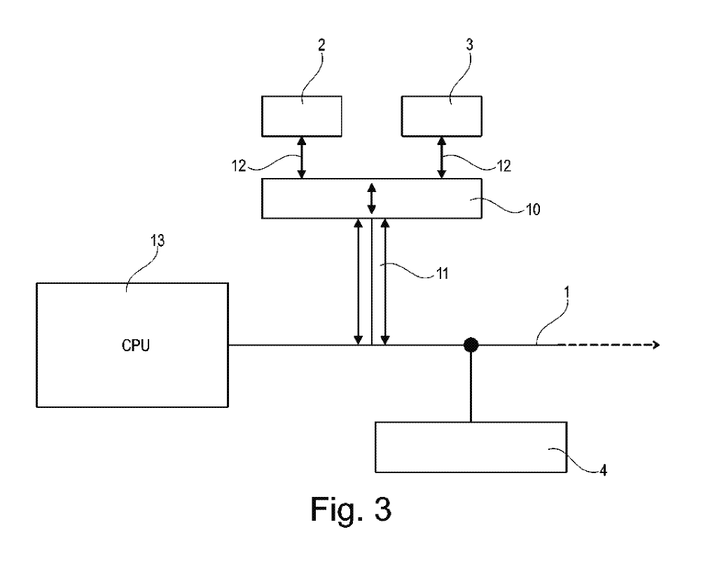

FIG. 3: shows second exemplary embodiment modified with respect to FIG. 2

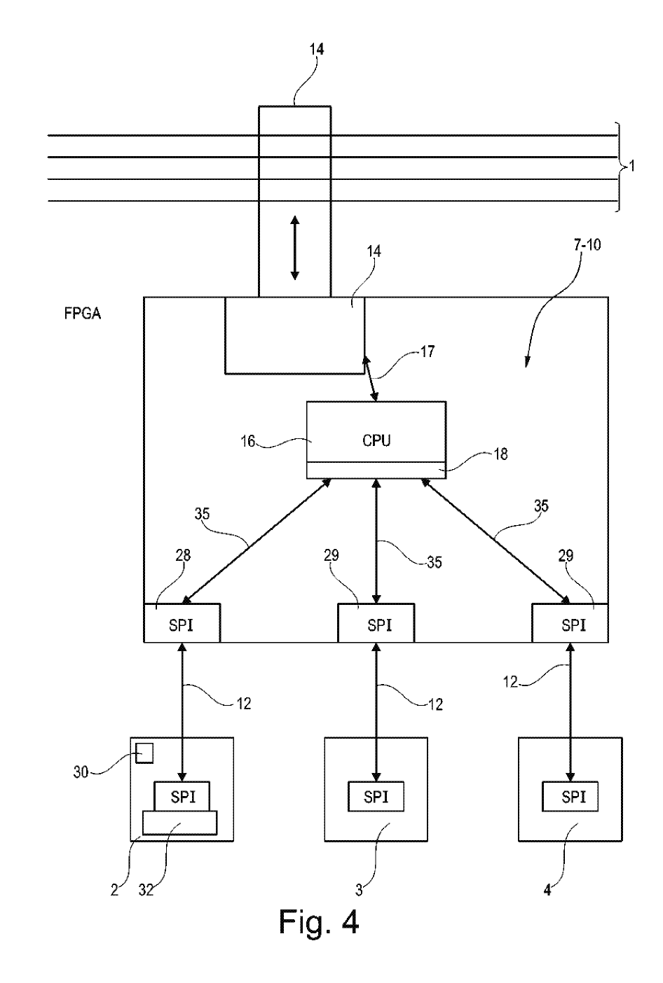

FIG. 4: shows a detailed representation of the switching module

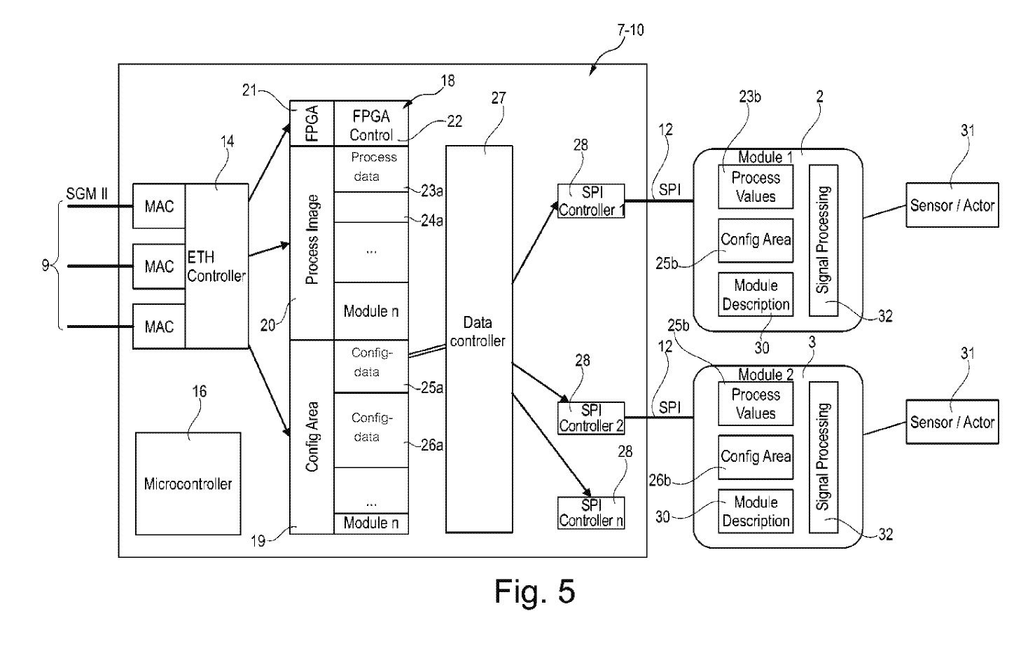

FIG. 5: shows a representation of the structure according to FIG. 4 as a block diagram

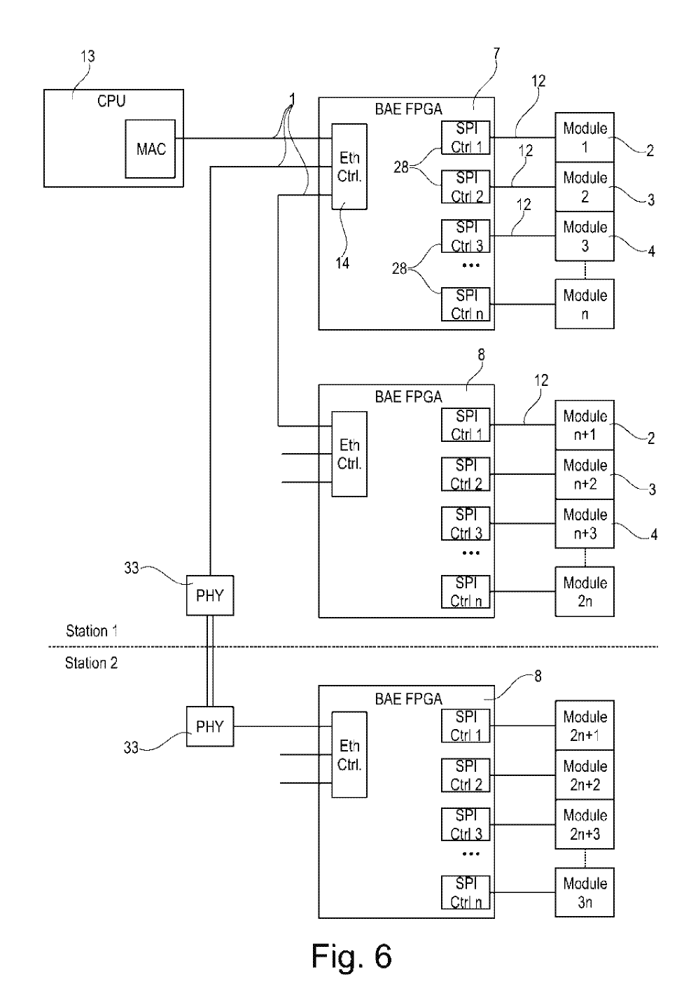

FIG. 6: shows the arrangement of a plurality of switching modules on a serial bus in the form of a block diagram

FIG. 1 shows a conventional serial bus 1 according to the prior art, which can be formed, for example, as a CAN bus, Profibus, Interbus-S, Profinet, Ethercat or in the manner of other known serial buses.

Characteristic of such serial buses is that the data transfer takes place in a closed ring and that the bus modules 2′, 3′, 4′ arranged in the closed serial bus experience the entire data throughput. Thus, the disadvantage exists that the number of modules to be arranged in such a serial bus is limited, as the temporal behavior in the bus is negatively influenced with the connection of each additional module.

Likewise, problems exist if a module fails, as then the data traffic to the other modules connected to the bus may be disrupted or may fail completely.

Moreover, the invention is not limited to the serial bus belonging to the prior art, but rather it also uses open bus systems, such as CAN buses, which, however, also operate as a serial buses.

According to FIG. 1, therefore, the disadvantage exists that the number of modules which can be received in such a serial bus 1 is limited, that the data traffic is disadvantageously influenced with the additional of further modules, and that in the failure of a module, the data traffic is disrupted or even fails.

The addition of each individual module also changes the temporal behavior of the modules enabled in the bus, which can lead to synchronization problems. Each module according to the prior art must command the protocol of the serial bus, complicated under certain circumstances, whereby a high circuitry and programming effort is produced.

The modules are therefore laborious with respect to circuitry, complex to program and accordingly prone to failure.

Even if the modules are to perform simple switching tasks, they must be complexly constructed in order to control the data traffic on the entire serial bus with their internal module control. Accordingly, the modules are also costly.

The invention therefore proposes to develop a serial bus system of the aforementioned type such that, independent of the number of modules arranged in the bus system, a constant data traffic is always ensured, which is independent of the number of modules present, and which is provided with an improved security from failure at a lower cost of the connected modules.

A feature of the invention is that in serial bus systems, the (complex) bus modules themselves no longer need to be connected, but rather only the switching modules, which map the (simple) standard modules connected to the switching module logically to the bus and, and that only the switching module executes the data traffic in the serial bus system in connection with the bus master.

The technical teaching provided results in the advantage that a consistent, high bandwidth of the data traffic in the serial bus is ensured, as it is no longer necessary to integrate the simple and partially also “dumb” modules themselves into the serial bus system at high expense, but rather only to integrate highly intelligent switching modules according to the invention in the bus system, which themselves control and administer the data traffic with the modules connected thereto.

This provides the advantage that even in the case of failure of a switching module, the data traffic to the other switching modules is not disrupted, as the switching module includes suitable emergency operating properties.

Furthermore, the advantage exists that even in the case of failure of one or more modules connected to the switching module, the data traffic in the serial bus system is not disrupted, as then the switching module, due to its intelligence, shuts down the connected, failed module or continues the data traffic with other modules connected to the switching module. The invention understands the term “module” as all input and output elements which are capable of realizing an external data traffic, for example to an analog receiver, a sensor or the like, whereby such a “module” preferably dispenses with a complex bus control logic and its own CPU.

Such a module, which is designed for example as an I/O module, has an interface to an external interconnection. And if such an I/O module were to fail, meaning for example through a short-circuit incineration, in the prior art the complete data traffic on the serial bus system would be interrupted, and the entire system would be unusable.

Here, the invention provides in such simple digital or analog modules that the (digital or analog) modules are now only indirectly connected to the serial bus, specifically via the switching module according to the invention.

In a further embodiment of the invention, it is provided that the switching module also administers the data traffic between the individual modules connected to the switching module, as a substantially lower circuit expenditure arises as compared to if—as in the prior art—the modules are integrated in a complex serial bus structure.

In the invention, this results that very simple modules, which can be produced at low cost, are connected to the respective switching module without great effort in terms of control or circuitry, and the data traffic between the simple module and the switching module is preferably controlled via an SPI bus system or another comparable bus system.

Such an SPI bus system is a simple four-wire system, which operates with its own frequency, wherein the frequency is specified by the switching module.

This results in the advantage that the modules, which are connected in different ways to different switching modules, can also be operated with different frequencies, which is not possible according to the prior art.

Thus, inexpensive and simple modules can be created, because even slow modules can be connected to associated switching modules according to their characteristics, and the switching module itself administers the data traffic on the serial bus system.

If several simple modules are connected to a switching module, the module-to-module communication may be made very quickly, because control mechanisms lying therebetween can be omitted, so that the modules can communicate with one another very quickly and without disrupting intermediate circuits.

Another advantage results from the fact that even complex tasks that a switching module must manage can be distributed to a plurality of modules connected thereto, so that the switching modules may also cultivate a very quick frequency in the serial bus due to the variously distributed task distribution.

In a disruption of the serial bus system, for example if the CPU bus master fails, it was disadvantageous in the prior art that the entire bus system was shut down and no further communication was possible.

Here is where the invention is applied, which provides that, in case of failure of the serial bus system, the individual switching modules can continue to operate and uphold the data traffic with the modules connected thereto. This is important in machine tools for example, where the modules are provided, for example, for tool control or for the tool changer, and if the serial bus fails, the tool changer can nevertheless continue to fulfill these or other limited tasks, as the switching module executes an emergency operating program and upholds the data traffic with the modules connected thereto.

Upon failure of the serial bus system, it is even possible that the intelligent switching module connected thereto executes a controlled and secured emergency operating service or executes a controlled shutdown of all services, whereby there is no damage to the connected modules and the machine controls connected thereto.

Formed according to the prior art, FIG. 1 shows that the individual complex (bus) modules 2′ to 4′, which are directly integrated in the bus structure, have interfaces to the outside world, wherein the interface 5 is an I/O interface for example, and the interface 6 is an Ethernet interface.

Starting from a serial bus according to FIG. 1, which is designed, for example, as a fieldbus, a novel serial bus according to FIG. 2 is proposed which is also formed, for example, as a fieldbus. However, the invention is not limited to a serial bus in its form as a fieldbus. In the general introduction to the description, other types of buses have been mentioned which all use the concept of the invention.

It is only shown by way of example in FIG. 2 that the invention does not exclude that complex (bus) modules 2′ to 4′ are also still arranged in the serial bus structure 1, although this is not necessarily desirable from the viewpoint of data traffic. In fact, the invention provides that instead of the integration of highly complex (bus) modules 2′, 3′ and 4′, which must follow all data traffic on the serial bus 1, only the switching modules 7-10 according to the invention are now present.

The data traffic is managed on the serial bus 1 by a CPU bus master 13.

Through the use of the switching modules 7-10 according to the invention, the advantage exists that the simple modules 2-4 which are now to be connected are no longer directly connected to the bus, but rather are only connected indirectly via the switching modules 7-10 to the serial bus 1 and communicate therewith.

Since all switching modules 7-10 are preferably formed identically, the further characteristics of a switching module are described with reference to the switching module 10 in FIG. 2 and the subsequent figures.

It is shown schematically that a plurality of simple modules 2-4 can be connected at each switching module 7-10, and the data traffic between the respective switching modules 7-10 and the modules 2-4 connected thereto takes place respectively via an SPI bus 12.

Such an SPI bus is a simple four-wire line, which is particularly simple in construction and which is formed from standard electrical elements, so that a particularly simple and stable data connection is provided between the connected modules 2-4 and the respective switching modules 7-10.

It was stated above that the number of modules 2′-3′ connected directly in the bus structure of the serial bus 1 is to be limited, namely in view of the advantages which arise with the present invention with the use of switching modules 7-10 connected to the bus system.

However, the invention also provides for the connection of such complex modules 2′ and 3′—for example from third-party manufacturers—in the serial bus structure of the serial bus 1 since, as previously, the bus is suitable and intended for the connection of such complex modules.

With regard to the connection of the simple modules 2, 3 according to the invention, FIG. 2 also shows symbolically that a cross connection 34 is provided between the individual modules 2, 3, which is nevertheless represented in FIG. 2 in terms of circuitry through the direct connection 11, meaning that the direct connection 34 is executed via the respective switching module 7-10.

In this way, a faster and more direct data traffic is provided between the individual modules 2-4 connected to a switching module 7-10, wherein the data traffic between the switching module and the respectively connected module can be selected in terms of frequency such that different frequencies are possible. This was not possible in the conventional bus system according to FIG. 1.

FIG. 3 shows an exemplary embodiment modified with respect to FIG. 2, in which embodiment a bus master 13 administers a serial bus 1, which need not necessarily be designed as a closed system. Only a single module 4′ is shown schematically in direct connection to the serial bus 1, wherein, however, according to the invention the switching module 10 is connected via a fieldbus interface 14 to the serial bus 1, and in turn, the modules 2, 3 are connected to the switching module 10 via the simple SPI bus 12.

Such a bus type, as is shown in FIG. 3, may be a CAN bus for example.

FIG. 4 shows the schematic internal structure of a switching module 7-10 according to the invention. It is first shown schematically that a data connection to the switching module 7-10 takes place from the side of the serial bus 1 via the fieldbus interface 14.

The signal traffic to a switching module CPU 16 integrated in a switching module takes place via the signal connection 17, which switching module CPU 16 communicates via its own data connection 35 with the respective SPI controller 28, which is a part of the switching module 7-10.

The SPI controllers 28, 29 each execute an individual data traffic via an SPI bus 12 with the module 2-4 connected there.

The modules 2, 3, 4 are of different construction, whereby it is shown in the exemplary embodiment that the module 2 has a data memory 30, with which it communicates the parameters associated with the module to the switching module via the SPI bus 12, so that management of the module 2 is possible from the side of the switching module.

Instead of a data memory 30, other elements may also be contained in the module; modules 3, 4 thus show suitable interface connections with which the modules 3, 4 communicate with the analog or digital outer world.

In the exemplary embodiment of FIG. 4, it is further shown that the switching module is associated with an FPGA module 18. This is a field programmable gate array, which means that the data traffic on the data connection 35 in the direction toward the SPI controller 28 is administered via such a programmable control system.

The SPI controller 28 may also be a part of the FPGA module 18.

It is also shown that in any given module, a data converter 32 may be provided, which is formed for example as an analog-to-digital converter and which can read analog signals, for example from sensors.

FIG. 5 shows a more detailed block diagram than FIG. 4, in which block diagram the serial bus is shown only schematically and operates by a fieldbus interface via an appropriate data transfer protocol.

The fieldbus interface is formed as an ETH controller and operates via logical connections to the aforementioned FPGA module.

This module is represented only in the form of logical blocks, and the logical blocks arranged on the input side are represented schematically as data blocks 19, 20, 21. The data blocks contain corresponding data; for example, data block 19 contains information regarding the configuration, data block 20 information regarding the running process and data block 21 information regarding the content and condition of the FPGA module 18.

The data structure of the FPGA module 18 is shown only schematically. A bus coupler controller 22 is present, which controls the number of modules 23a, 24a, 25a, 26a. The modules 23a-26a are the logical mapping of the externally connected modules 2, 3 in the FPGA module 18.

However, the modules 23a-24a are not the total mapping of the externally connected modules 2, 3, but rather only the process mapping, which is designated in the representation according to FIG. 5 with the reference characters 23b, 24b. Therefore, the module 23a is the logical mapping of the logical module 23b present in the module 2, with which the process data in the FPGA module is mirrored.

The same applies to the other modules, designated by the letter b, which are respectively mirrored in the FPGA module with the letter a at the correspondingly marked location.

The data structure of the FPGA module is thus described by the representation in FIG. 5, and this data structure is managed by a data controller 27.

Reference is made accordingly to logical modules 23a, 24a, 25a, 26a, which carry out the mapping of the data structure from the externally connected modules 2-4 to the data structure of the FPGA module.

It can also be understood from FIG. 5 that analog sensors 31 may be connected, the signals of which are read via a data converter 32 in the respective module 2-4.

FIG. 6 shows the interconnection of a plurality of switching modules 7-10 according to the invention in a bus structure of the serial bus 1.

It is shown here that the CPU bus master 13 manages the serial bus 1, and a plurality of switching modules 7, 8, 9 are connected thereto. Each switching module has a fieldbus interface 14, with which the data traffic to the serial bus 1 is initiated.

A plurality of SPI controllers are present in each switching module 7-10, which SPI controllers are managed by the aforementioned data controller 27. Each SPI controller 28 works with the respectively connected module 2-4 via its own SPI bus.

It is thus possible for the first time that each module 2 can initiate a data traffic with the switching module individually via an SPI bus connected thereto, and that the frequency on the individual SPI bus systems 12 may therefore be different.

If a switching module fails, for example the switching module 7, the bus-side data traffic is still carried by the other switching modules 8, 9, 10.

If a module 2-4 fails, this is then detected by the respective switching module 7-10 and the data traffic with the remaining modules 2-4 is continued.

It is also possible in this way to easily change the modules 2-4, without causing an interruption of the data traffic on the serial bus.

The change may thus take place during operation (plug and play), without necessitating the switching on of an interruption program.

In one development of the invention, it is provided that a user program runs in the switching module CPU. It can react very quickly, as according to FIG. 5 the user program runs in the switching module CPU 16 and in the microcontroller located there, which thus controls the FPGA and the data structure of the externally connected modules mirrored there.

For this reason, fast signal changes of the connected modules 2-4 can also be processed, as the data structure thereof is mirrored in the FPGA and processed there.

A data traffic via the slower serial bus 1 is therefore not necessary.

### LEGEND OF DRAWINGS

1 serial bus
2 modules (FPGA—I/O modules)
2′ bus module
3 modules
3′ bus module
4 modules
4′ bus module
5 interface
6 interface
7 switching module
8 switching module
9 switching module
10 switching module
11 direct connection
12 SPI bus
13 CPU bus master
14 fieldbus interface
15 interface
16 switching module CPU
17 signal connection
18 FPGA module
19 data block
20 data block
21 data block
22 bus coupler controller
23a, 23b logical module
24a, 24b logical module
25a, 25b logical module
26a, 26b logical module
27 data controller
28 SPI controller
30 data memory
31 sensor
32 data converter
33 signal driver
34 cross connection
35 data connection

1. A serial bus system with a plurality of bus modules (2′-4′) connected thereto, wherein the data traffic can be administered on the serial bus (1) by means of at least one CPU bus master (13), characterized in that the bus modules (2′-4′) connected in the serial bus (1) are each distributed in a switching module (7-10) connected directly to the serial bus (1) and one or more simple modules (2-4) which are connected only to the switching module (7-10).

2. The serial bus system according to claim 1, characterized in that the switching modules (7-10) connected in the serial bus (1) map the (simple) standard modules (2-4) connected thereto logically to the bus (1) and that the switching modules (7-10) execute the data traffic in the serial bus (1) in connection with the CPU bus master (13).

3. The serial bus system according to claim 1, characterized in that the module (2-4), connected only indirectly to the serial bus (1), is formed as a simple input and output element, which executes an external data traffic to an analog receiver or a sensor or the like, and which does not have complex bus control logic with its own CPU.

4. The serial bus system according to claim 1, characterized in that a plurality of simple modules (2-4) are connected to one switching module (7-10) and that the switching module (7-10) administers the data traffic between the individual modules (2-4) connected thereto.

5. The serial bus system according to claim 4, characterized in that the data traffic between the simple module (2-4) and the switching module (7-10) can be controlled via an SPI bus (12) or another comparable bus system.

6. The serial bus system according to claim 1, characterized in that the modules (2-4), which are connected to different switching modules (7-10), can be operated with different frequencies.

7. The serial bus system according to claim 1, characterized in that in case of failure of the serial bus (1), the individual switching modules (7-10) uphold the data traffic with the modules (2-4) connected thereto.

8. The serial bus system according to claim 1, characterized in that the data connection from the switching module (7-10) to the serial bus (1) takes place via a fieldbus interface (14).

9. The serial bus system according to claim 8, characterized in that the fieldbus interface (14) executes the signal traffic to a switching module CPU (16) integrated in the switching module (7-10) via a signal connection (17), which switching module CPU (16) communicates via a data connection (35) with an SPI controller (28), which controls the data traffic with the externally connected modules (2-4) via the SPI bus (12).

10. The serial bus system according to claim 1, characterized in that the simple modules (2-4) connected to the switching modules (7-10) have a data memory (30), in which the operating, working and condition parameters associated with the module (2-4) are supplied to the switching module (7-10) via the SPI bus (12).

11. The serial bus system according to claim 1, characterized in that the modules (2-4) can be changed during operation without affecting the data traffic of the entire bus system.
